(19) United States
(12) Patent Application Publication
(10) Pub. No.: US 2026/0079353 A1
(43) Pub. Date: Mar. 19, 2026

(54) WEARABLE ELECTRONIC DEVICE

(71) Applicant: Samsung Electronics Co., Ltd., Suwon-si (KR)

(72) Inventors: Youngmin MOON, Suwon-si (KR); Taejeong KIM, Suwon-si (KR); Byounggyu PARK, Suwon-si (KR); Jaehyun BAE, Suwon-si (KR); Kyunghwan SONG, Suwon-si (KR); Areum YOO, Suwon-si (KR); Changsu LEE, Suwon-si (KR); Sooyoung CHOI, Suwon-si (KR); Hyunsuk CHOI, Suwon-si (KR)

(21) Appl. No.: 19/402,183

(22) Filed: Nov. 26, 2025

Related U.S. Application Data
(63) Continuation of application No. PCT/KR2024/010382, filed on Jul. 18, 2024.

(30) Foreign Application Priority Data
Jul. 25, 2023 (KR) 10-2023-0096985
Sep. 12, 2023 (KR) 10-2023-0121377

(51) Int. Cl. G02B 27/01; G02B 7/04; G06F 1/16

(52) U.S. Cl. CPC G02B 27/0172; G02B 7/04; G06F 1/163; G02B 2027/0178

(57) ABSTRACT

A wearable electronic device is provided. The wearable electronic device includes a display configured to output visual information, and a lens assembly configured to allow the visual information output from the display to pass through, wherein the lens assembly includes a body tube forming a space therein, a first lens including a first lens circumferential portion and a second lens circumferential portion, the first lens circumferential portion at least partially extending along a circumferential direction of the body tube, the second lens circumferential portion being connected to the first lens circumferential portion and forming a bending portion, a second lens disposed inside the body tube and spaced apart from the first lens, a support member disposed between the first lens and the second lens, the support member including a first support portion and a second support portion, the first support portion extending along the first lens circumferential portion, the second support portion corresponding to the second lens circumferential portion and being spaced apart from the second lens circumferential portion, and a shielding member disposed between the second lens circumferential portion and the second support portion.

### CROSS-REFERENCE TO RELATED APPLICATION(S)

This application is a continuation application, claiming priority under 35 U.S.C. § 365 (c), of an International application No. PCT/KR2024/010382, filed on Jul. 18, 2024, which is based on and claims the benefit of a Korean patent application number 10-2023-0096985, filed on Jul. 25, 2023, in the Korean Intellectual Property Office, and of a Korean patent application number 10-2023-0121377, filed on Sep. 12, 2023, in the Korean Intellectual Property Office, the disclosure of each of which is incorporated by reference herein in its entirety.

### BACKGROUND

### 1. Field

The disclosure relates to a wearable electronic device. More particularly, the disclosure relates to a wearable electronic device including a shielding member.

### 2. Description of Related Art

Electronic devices for portable purposes, such as electronic organizers, portable multimedia players, mobile communication terminals, or tablet personal computers (PCs), are generally equipped with a display member (e.g., a display) and a battery, and have an appearance of a bar type, folder type, or sliding type due to the shape of the display member or the battery. Recently, as the performance of the display member and the battery has improved, they have been miniaturized, leading to the commercialization of wearable electronic devices that may be worn on a part of the body, such as the wrist or the head. Since the wearable electronic devices are worn directly on the body, their portability and/or user accessibility may be enhanced.

Among the wearable electronic devices, an electronic device configured to be worn on a user's face, for example, a head-mounted device (HMD), is disclosed. The HMD may be useful in implementing virtual reality or augmented reality. For example, the wearable electronic device may implement virtual reality by stereoscopically providing images of a virtual space in a game that was previously enjoyed through a television or a computer monitor, while blocking images of an actual space where the user is located. Another type of wearable electronic device may provide augmented reality, which provides various pieces of visual information to the user by implementing a virtual image while providing an environment in which the user may visually perceive a real image of a space where the user is located.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device including a shielding member.

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes a display configured to output visual information, and a lens assembly configured to allow the visual information output from the display to pass through, wherein the lens assembly includes a body tube forming a space therein, a first lens including a first lens circumferential portion and a second lens circumferential portion, the first lens circumferential portion at least partially extending along a circumferential direction of the body tube, the second lens circumferential portion being connected to the first lens circumferential portion and forming a bending portion, a second lens disposed inside the body tube and spaced apart from the first lens, a support member disposed between the first lens and the second lens, the support member including a first support portion and a second support portion, the first support portion extending along the first lens circumferential portion, the second support portion corresponding to the second lens circumferential portion and being spaced apart from the second lens circumferential portion, and a shielding member disposed between the second lens circumferential portion and the second support portion.

In accordance with another aspect of the disclosure, a wearable electronic device is provided. The wearable electronic device includes a display configured to output visual information, and a lens assembly configured to allow the visual information output from the display to pass through, wherein the lens assembly includes a first circumferential portion and a second circumferential portion having a curvature smaller than the first circumferential portion, a lens including a first lens circumferential portion corresponding to the first circumferential portion and a second lens circumferential portion corresponding to the second circumferential portion, a support member including a first support portion coupled to the first lens circumferential portion and a second support portion connected to the first support portion and spaced apart from the second lens circumferential portion, and a shielding member disposed between the second lens circumferential portion and the second support portion.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a perspective view illustrating an internal configuration of a wearable electronic device according to an embodiment of the disclosure;

FIG. 3 is a front view illustrating a wearable electronic device according to an embodiment of the disclosure;

FIG. 4 is a rear view illustrating a wearable electronic device according to an embodiment of the disclosure;

FIG. 5 is a conceptual view illustrating a portion of a wearable electronic device and a user's nose according to an embodiment of the disclosure;

FIG. 6A is a partial cross-sectional view taken along a reference line B-B′ illustrated in FIG. 5 according to an embodiment of the disclosure;

FIG. 6B is a diagram illustrating a portion of a lens assembly according to an embodiment of the disclosure;

FIG. 7 is an exploded view illustrating a lens assembly according to an embodiment of the disclosure;

FIG. 8A is a cross-sectional view taken along a reference line A-A′ illustrated in FIG. 5 according to an embodiment of the disclosure;

FIG. 8B is a cross-sectional view taken along the reference line B-B′ illustrated in FIG. 5 according to an embodiment of the disclosure;

FIG. 9A is a diagram illustrating a portion of a lens assembly according to an embodiment of the disclosure;

FIG. 9B is a diagram illustrating a portion of a lens assembly according to an embodiment of the disclosure;

FIG. 10 is an enlarged view illustrating a portion of a lens assembly according to an embodiment of the disclosure;

FIG. 11A is an enlarged view illustrating a portion of a lens assembly according to an embodiment of the disclosure;

FIG. 11B is an enlarged view illustrating a portion of a lens assembly according to an embodiment of the disclosure;

FIG. 11C is an enlarged view illustrating a portion of a lens assembly according to an embodiment of the disclosure;

FIG. 11D is an enlarged view illustrating a portion of a lens assembly according to an embodiment of the disclosure;

FIG. 12A is a perspective view illustrating a support member according to an embodiment of the disclosure;

FIG. 12B is a perspective view illustrating a lens according to an embodiment of the disclosure;

FIG. 12C is a perspective view illustrating a film according to an embodiment of the disclosure; and

FIG. 13 is a conceptual view illustrating a portion of a wearable electronic device and a user's nose according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

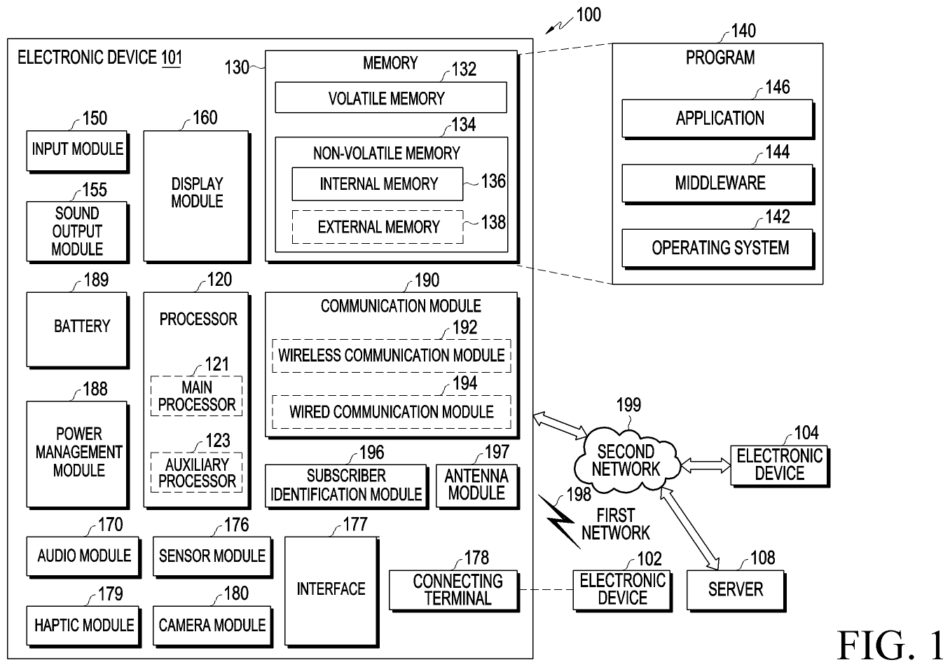

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi™) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g., electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

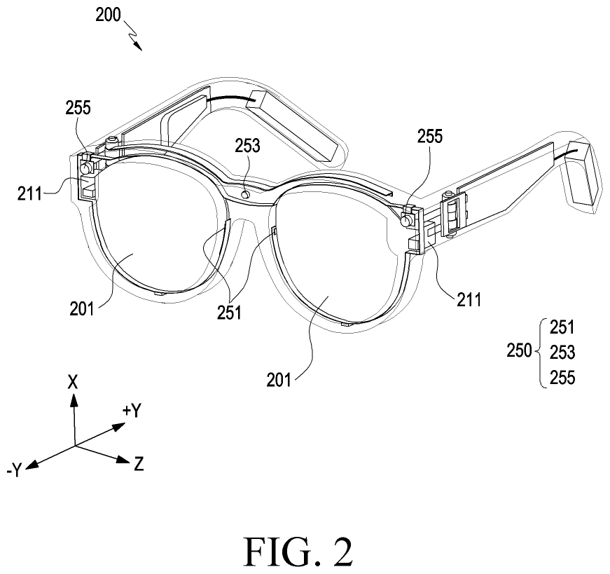

FIG. 2 is a perspective view illustrating an internal configuration of a wearable electronic device according to an embodiment of the disclosure.

Referring to FIG. 2, a wearable electronic device 200 according to an embodiment of the disclosure may include at least one of a light output module 211, a display member 201, or a camera module 250.

According to an embodiment, the wearable electronic device 200 may be a body-worn device. For example, the wearable electronic device 200 may be a head-mounted device (HMD), smart glasses, or a video see through (VST) device capable of providing images directly in front of the user's eyes. Although the wearable electronic device 200 is shown as having the appearance of goggles in the illustrated embodiment, the wearable electronic device 200 of the disclosure is not limited thereto and may have various types of appearances. The wearable electronic device 200 may provide a pass-through function. The wearable electronic device 200 may be referred to as a pass-through device.

According to an embodiment, the light output module 211 may include a light source capable of outputting an image, and a lens that guides the image to the display member 201. According to an embodiment of the disclosure, the light output module 211 may include at least one of a liquid crystal display (LCD), a digital mirror device (DMD), a liquid crystal on silicon (LCoS), a light emitting diode (LED) on silicon (LEDoS), an organic light emitting diode (OLED), or a micro LED. The light output module 211 may be referred to as a “display”.

According to an embodiment of the disclosure, the display member 201 may include an optical waveguide (e.g., a waveguide). The display member 201 may be referred to as a “display”. According to an embodiment of the disclosure, an output image of the light output module 211 incident on one end of the optical waveguide may be propagated through the optical waveguide and provided to a user. According to an embodiment of the disclosure, the optical waveguide may include at least one of a diffractive optical element (DOE), a holographic optical element (HOE)), or a reflective element (e.g., a reflective mirror). For example, the optical waveguide may guide the output image of the light output module 211 to the user's eyes by including at least one of the DOE, the HOE, or the reflective element (e.g., a reflective mirror).

According to an embodiment of the disclosure, the camera module 250 may capture a still image and/or a video. According to an embodiment, the camera module 250 may be disposed within a lens frame and disposed around the display member 201.

According to an embodiment of the disclosure, a first camera module 251 may capture and/or recognize the trajectory of the user's eyes (e.g., pupils or irises) or gaze. According to an embodiment of the disclosure, the first camera module 251 may periodically or aperiodically transmit information (e.g., trajectory information) related to the trajectory of the user's eyes or gaze to a processor (e.g., the processor 120 of FIG. 1). The first camera module 251 may receive light irradiated from a lamp (e.g., a lamp 328 of FIG. 4) and reflected from the user's eyes.

According to an embodiment of the disclosure, a second camera module 253 may capture an external image.

According to an embodiment of the disclosure, a third camera module 255 may be used for hand detection and tracking, and user gesture (e.g., hand action) recognition. The third camera module 255 according to an embodiment of the disclosure may be used for 3 degrees of freedom (3DoF) or 6DoF head tracking, location (space or environment) recognition, and/or movement recognition. The second camera module 253 may also be used for hand detection and tracking, and user gesture recognition according to an embodiment of the disclosure. According to an embodiment of the disclosure, at least one of the first camera module 251 to the third camera module 255 may be replaced with a sensor module (e.g., a LiDAR sensor). For example, the sensor module may include at least one of a vertical cavity surface emitting laser (VCSEL), an IR sensor, and/or a photodiode.

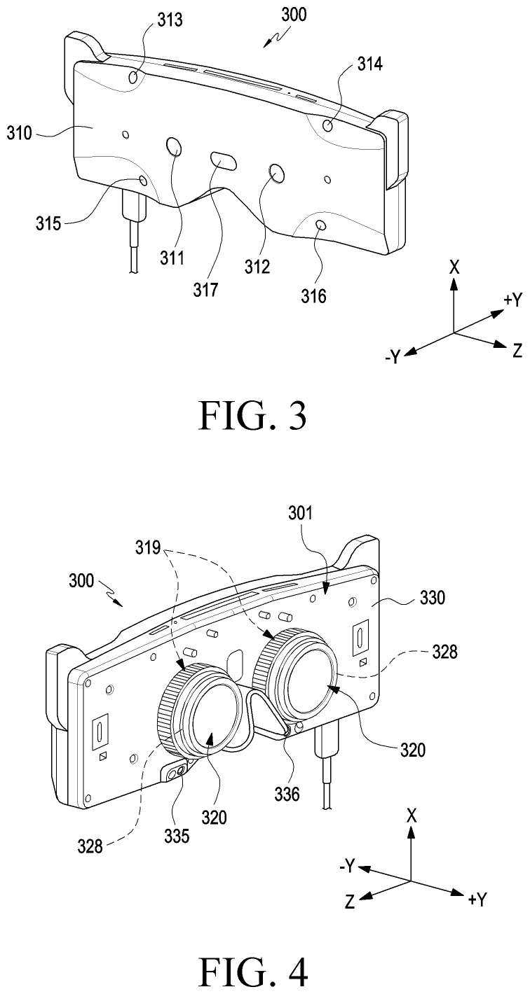

FIGS. 3 and 4 are diagrams illustrating the front and rear surfaces of a wearable electronic device according to various embodiments of the disclosure.

Referring to FIGS. 3 and 4, in an embodiment, a wearable electronic device 300 may include a housing 301. The housing 301 may include a first surface 310 and a second surface 330.

Referring to FIGS. 3 and 4, in an embodiment, camera modules 311, 312, 313, 314, 315, and 316 and/or a depth sensor 317 may be disposed on the first surface 310 of the housing 301 to obtain information related to a surrounding environment of the wearable electronic device 300.

In an embodiment, the camera modules 311 and 312 may obtain an image related to the surrounding environment of the wearable electronic device 300.

In an embodiment, the camera modules 313, 314, 315, and 316 may obtain an image, while the wearable electronic device 300 is worn by the user. The camera modules 313, 314, 315, and 316 may be used for hand detection and tracking, and user gesture (e.g., hand action) recognition. The camera modules 313, 314, 315, and 316 may be used for 3DoF or 6DoF head tracking, location (space or environment) recognition, and/or movement recognition. In an embodiment, the camera modules 311 and 312 may also be used for hand detection and tracking, and user gesture recognition.

In an embodiment, the depth sensor 317 may be configured to transmit a signal and receive a signal reflected from an object, and used for the purpose of identifying a distance to an object, such as time of flight (TOF). Alternatively or additionally to the depth sensor 217, the camera modules 313, 314, 315, and 316 may identify a distance to an object.

According to an embodiment, the wearable electronic device 300 may include a display 319. The display 319 may output visual information through a lens assembly 320. The lens assembly 320 may be identical to the light output module 211 described before with reference to FIG. 2.

According to an embodiment, face recognition camera modules 335 and 336 and/or the lens assembly 320 (and/or the display) may be disposed on the second surface 330 of the housing.

In an embodiment, the face recognition camera modules 335 and 336 adjacent to the display 319 may be used for the purpose of recognizing the user's face or may recognize and/or track both eyes of the user.

In an embodiment, the lens assembly 320 (and/or the display) may be disposed on the second surface 330 of the wearable electronic device 300. In an embodiment, the wearable electronic device 300 may not include the camera modules 315 and 316 among a plurality of camera modules 313, 314, 315, and 316. Although not shown in FIGS. 3 and 4, the wearable electronic device 300 may further include at least one of the components illustrated in FIG. 2.

As described above, according to an embodiment, the wearable electronic device 300 may have a form factor for being worn on the user's head. The wearable electronic device 300 may further include a strap and/or a wearing member to be secured on the user's body part. The wearable electronic device 300 may provide a user experience based on augmented reality, virtual reality, and/or mixed reality, while worn on the user's head.

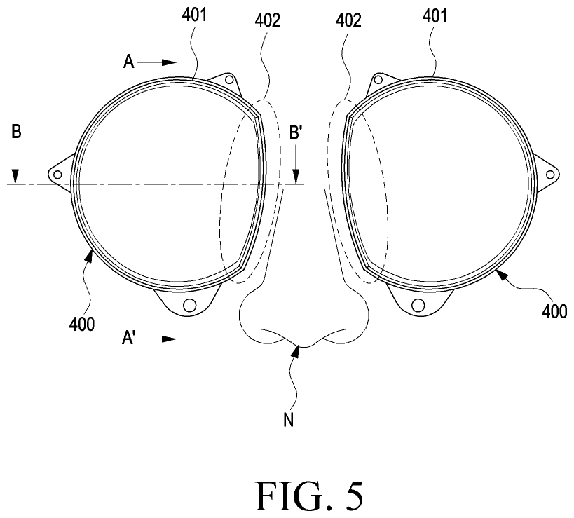

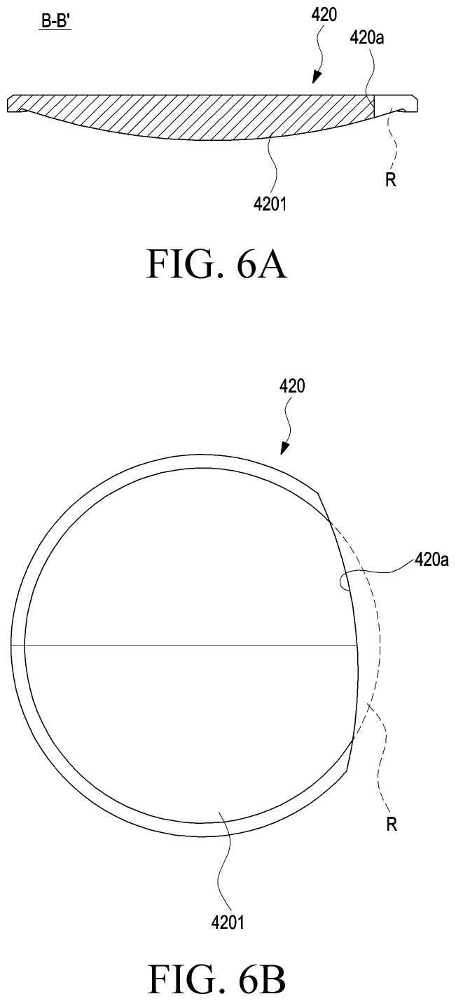

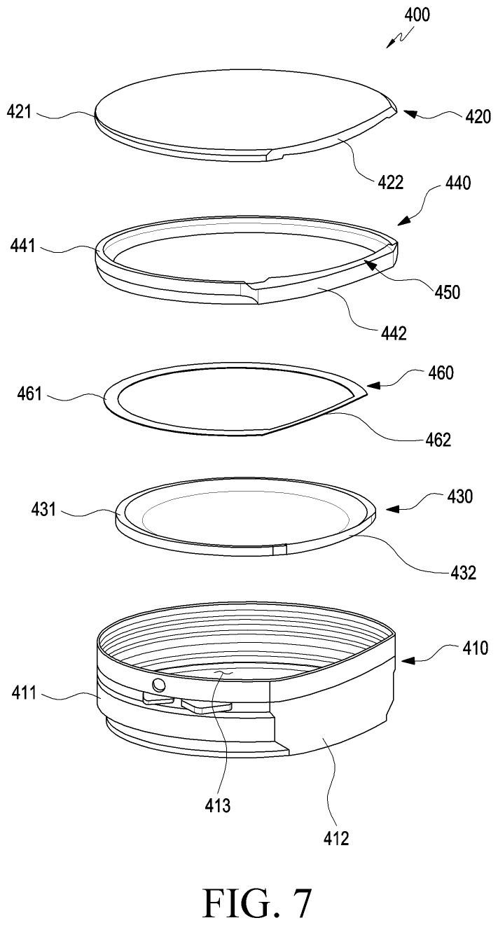

FIG. 5 is a diagram selectively illustrating only a lens assembly 400 and a user's nose N, while the user wears a wearable electronic device (e.g., the wearable electronic device 300 of FIG. 4) according to an embodiment of the disclosure. FIG. 6A is a cross-sectional view of the lens assembly 400 taken along a reference line B-B′ of FIG. 5, selectively illustrating only a lens 420 according to an embodiment of the disclosure. FIG. 6B is a diagram illustrating the lens 420 separately from the lens assembly 400 according to an embodiment of the disclosure. The components described with reference to FIGS. 5, 6A, and 6B may be partially or entirely the same as the components described with reference to FIGS. 1 to 4. The components described with reference to FIGS. 5, 6A, and 6B may be partially or entirely the same as the components described with reference to FIGS. 7, 8A, 8B, 9A, 9B, 10, 11A to 11D, 12A to 12C, and 13.

Referring to FIGS. 5, 6A, and 6B, according to an embodiment, a wearable electronic device (e.g., the wearable electronic device 300 of FIG. 4) may include a lens assembly 400. When the user wears the wearable electronic device (e.g., the wearable electronic device 300 of FIG. 4), the user's nose N may be located between a pair of lens assemblies 400. The lens assembly 400 may be the same as the lens assembly 320 of FIG. 4. The lens assembly 400 may be located adjacent to the user's nose N. The lens assembly 400 according to an embodiment of the disclosure may include a first circumferential portion 401 and a second circumferential portion 402. The second circumferential portion 402 may be a portion of the lens assembly 400 located adjacent to the user's nose N, and the first circumferential portion 401 may be a portion of the lens assembly 400 located further away from the user's nose N than the second circumferential portion 402. The first circumferential portion 401 and the second circumferential portion 402 may be connected to each other and formed integrally. A curvature of the first circumferential portion 401 may be greater than a curvature of the second circumferential portion 402.

According to an embodiment, the lens 420 may include a body 4201 having a cut surface 420a. The body 4201 may extend along a circumferential direction of the lens assembly 400. The lens 420 may have a shape which is at least partially cut off. For example, the lens 420 may have a disk shape which is at least partially cut off. The lens 420 may undergo a machining process that cuts off a portion (e.g., a cut portion R in FIGS. 6A and 6B) from the disk shape. The portion (e.g., the cut portion R in FIGS. 6A and 6B) cut during a manufacturing process of the lens 420 may be a portion adjacent to the user's nose N, when the user wears the wearable electronic device (e.g., the wearable electronic device 300 of FIG. 4). The wearable electronic device (e.g., the wearable electronic device 300 of FIG. 4) according to an embodiment of the disclosure may reduce interference between the wearable electronic device and a specific body part (e.g., the nose N) by cutting off a portion of the lens assembly 400 adjacent to the body part.

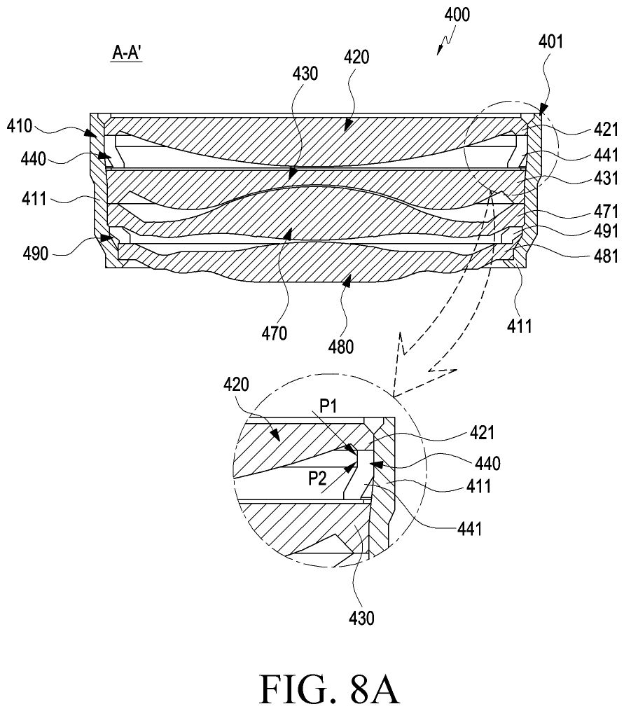

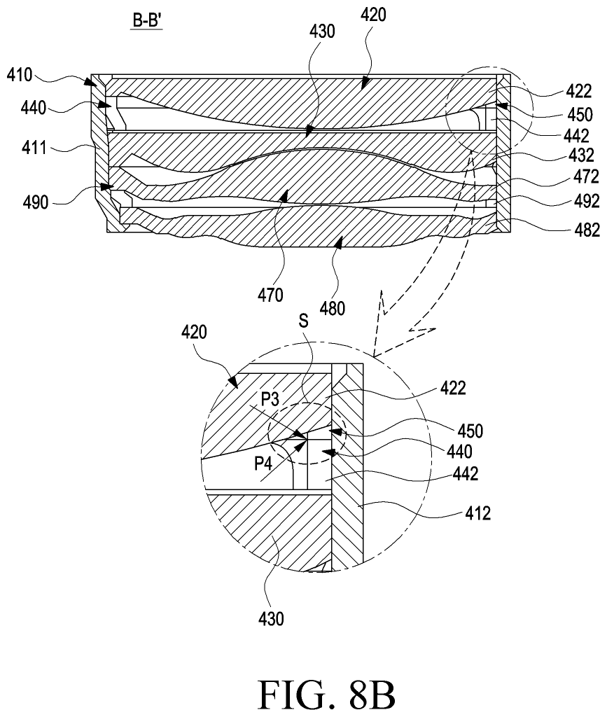

FIG. 7 is an exploded view illustrating the lens assembly 400 according to an embodiment of the disclosure. The components described with reference to FIG. 7 may be partially or entirely the same as the components described with reference to FIGS. 1 to 5, 6A, and 6B. The components described with reference to FIG. 7 may be partially or entirely the same as the components described with reference to FIGS. 8A, 8B, 9A, 9B, 10, 11A to 11D, 12A to 12C, and 13.

Referring to FIG. 7, according to an embodiment, the lens assembly 400 may include a body tube 410. The body tube 410 may form a surface of the lens assembly 400. The body tube 410 may include a first body tube circumferential portion 411 and a second body tube circumferential portion 412. The first body tube circumferential portion 411 and the second body tube circumferential portion 412 may be connected to each other and formed integrally. A curvature of the first body tube circumferential portion 411 may be greater than a curvature of the second body tube circumferential portion 412. The first body tube circumferential portion 411 may be disposed in a position corresponding to the first circumferential portion (e.g., the first circumferential portion 401 of FIG. 5) of the lens assembly 400. The second body tube circumferential portion 412 may be disposed in a position corresponding to the second circumferential portion (e.g., the second circumferential portion 402 of FIG. 5) of the lens assembly 400.

According to an embodiment, the lens assembly 400 may include a first lens 420. The first lens 420 may be referred to as a “lens”. The first lens 420 may be disposed in an internal space 413 of the body tube 410. The first lens 420 may be coupled to the body tube 410. The first lens 420 may include a first lens circumferential portion 421 and a second lens circumferential portion 422. The first lens circumferential portion 421 and the second lens circumferential portion 422 may be connected to each other and formed integrally. A curvature of the first lens circumferential portion 421 may be greater than a curvature of the second lens circumferential portion 422. The first lens circumferential portion 421 may be disposed in a position corresponding to the first circumferential portion (e.g., the first circumferential portion 401 of FIG. 5) of the lens assembly 400. The second lens circumferential portion 422 may be disposed in a position corresponding to the second circumferential portion (e.g., the second circumferential portion 402 of FIG. 5) of the lens assembly 400. The first lens circumferential portion 421 may be referred to as a “(1-1)^{th} lens circumferential portion”. The second lens circumferential portion 422 may be referred to as a “(1-2)^{th} lens circumferential portion”.

According to an embodiment, the lens assembly 400 may include a second lens 430. The second lens 430 may be referred to as a “lens”. The second lens 430 may be disposed in the internal space 413 of the body tube 410. The first lens 420 and the second lens 430 may be spaced apart from each other. The second lens 430 may be coupled to the body tube 410. The second lens 430 may include a first lens circumferential portion 431 and a second lens circumferential portion 432. The first lens circumferential portion 431 and the second lens circumferential portion 432 may be connected to each other and formed integrally. A curvature of the first lens circumferential portion 431 may be greater than a curvature of the second lens circumferential portion 432. The first lens circumferential portion 431 may be disposed in a position corresponding to the first circumferential portion (e.g., the first circumferential portion 401 of FIG. 5) of the lens assembly 400. The second lens circumferential portion 432 may be disposed in a position corresponding to the second circumferential portion (e.g., the second circumferential portion 402 of FIG. 5) of the lens assembly 400. The first lens circumferential portion 431 may be referred to as a “(2-1)^{th} lens circumferential portion”. The second lens circumferential portion 432 may be referred to as a “(2-2)^{th} lens circumferential portion”.

According to an embodiment, the lens assembly 400 may include a support member 440. The support member 440 may be disposed in the internal space 413 of the body tube 410. The support member 440 may be disposed between the first lens 420 and the second lens 430. The support member 440 may be coupled to the body tube 410. The support member 440 may include a first support portion 441 and a second support portion 442. The first support portion 441 and the second support portion 442 may be connected to each other and formed integrally. A curvature of the first support portion 441 may be greater than a curvature of the second support portion 442. The first support portion 441 may be disposed in a position corresponding to the first circumferential portion (e.g., the first circumferential portion 401 of FIG. 5) of the lens assembly 400. The second support portion 442 may be disposed in a position corresponding to the second circumferential portion (e.g., the second circumferential portion 402 of FIG. 5) of the lens assembly 400.

According to an embodiment, the lens assembly 400 may include a shielding member 450. The shielding member 450 may be disposed between the lens 420 and the support member 440. The shielding member 450 may be disposed between the second lens circumferential portion 422 and the second support portion 442. The shielding member 450 may be disposed in a position corresponding to the second circumferential portion (e.g., the second circumferential portion 402 of FIG. 5) of the lens assembly 400.

According to an embodiment, the lens assembly 400 may include a film 460. The film 460 may be disposed in the internal space 413 of the body tube 410. The film 460 may be attached to the lens 420. The film 460 may extend along a circumferential direction of the lens 420. The film 460 may include a first film circumferential portion 461 and a second film circumferential portion 462. The first film circumferential portion 461 and the second film circumferential portion 462 may be connected to each other and formed integrally. A curvature of the first film circumferential portion 461 may be greater than a curvature of the second film circumferential portion 462. The first film circumferential portion 461 may be disposed in a position corresponding to the first circumferential portion (e.g., the first circumferential portion 401 of FIG. 5) of the lens assembly 400. The second film circumferential portion 462 may be disposed in a position corresponding to the second circumferential portion (e.g., the second circumferential portion 402 of FIG. 5) of the lens assembly 400.

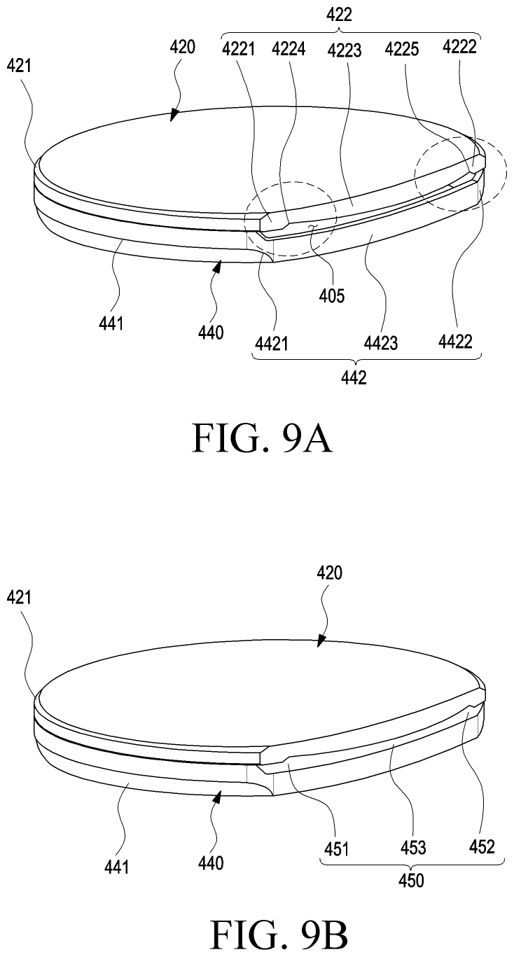

FIG. 8A is a cross-sectional view of the lens assembly 400, taken along a reference line A-A′ illustrated in FIG. 5 according to an embodiment of the disclosure. FIG. 8B is a cross-sectional view of the lens assembly 400, taken along the reference line B-B′ illustrated in FIG. 5 according to an embodiment of the disclosure. The components described with reference to FIGS. 8A and 8B may be partially or entirely the same as the components described with reference to FIGS. 1 to 5, 6A, 6B, and 7. The components described with reference to FIGS. 8A and 8B may be partially or entirely the same as the components described with reference to FIGS. 9A, 9B, 10, 11A to 11D, 12A to 12C, and 13.

According to an embodiment, the lens assembly 400 may include a plurality of lenses 420, 430, 470, and 480. The plurality of lenses 420, 430, 470, and 480 may be disposed inside the body tube 410. The plurality of lenses 420, 430, 470, and 480 may be spaced apart from each other. The plurality of lenses 420, 430, 470, and 480 may include a first lens 420, a second lens 430, a third lens 470, and a fourth lens 480. The description of the first lens 420 may be applied equally to the third lens 470. The description of the second lens 430 may be applied equally to the fourth lens 480.

According to an embodiment, the lens assembly 400 may include a plurality of support members 440 and 490. The plurality of support members 440 and 490 may be disposed between a pair of lenses (e.g., the first lens 420 and the second lens 430 spaced apart from each other). The plurality of support members 440 and 490 may include a first support member 440 and a second support member 490. The first support member 440 may be disposed between the first lens 420 and the second lens 430. The second support member 490 may be disposed between the third lens 470 and the fourth lens 480. The description of the first support member 440 may be applied equally to the second support member 490.

Referring to FIG. 8A, the lens assembly 400 may include the first circumferential portion 401. The first body tube circumferential portion 411, first lens circumferential portions 421, 431, 471, and 481, and first support portions 441 and 491 may be disposed in the first circumferential portion 401. The first lens 420 may include the (1-1)^{th} lens circumferential portion 421. The (1-1)^{th} lens circumferential portion 421 may be referred to as the “first lens circumferential portion”. The second lens 430 may include the (2-1)^{th} lens circumferential portion 431. The third lens 470 may include a (3-1)^{th} lens circumferential portion 471. The fourth lens 480 may include a (4-1)^{th} lens circumferential portion 481. The description of the first lens circumferential portion 421 may be applied equally to the (2-1)^{th} lens circumferential portion 431, the (3-1)^{th} lens circumferential portion 471, and the (4-1)^{th} lens circumferential portion 481. The first lens circumferential portion 421 may be a portion of the lens 420 located in the first circumferential portion 401 of the lens assembly 400. The first support member 440 may include a (1-1)^{th} support portion 441. The (1-1)^{th} support portion 441 may be referred to as a “first support portion”. The second support member 490 may include a (2-1)^{th} support portion 491. The description of the first support portion 441 may be applied equally to the (2-1)^{th} support portion 491. The first support portion 441 may be a portion of the support member 440 located in the first circumferential portion 401 of the lens assembly 400.

According to an embodiment, the first lens circumferential portion 421 may be seated on the first support portion 441. The first lens circumferential portion 421 and the first support portion 441 may contact each other. A space between the first lens circumferential portion 421 and the first support portion 441 may be sealed. Light passing through the lenses 420 and 430 may be blocked by the first support portion 441. Light refracted by the first lens 420 and proceeding along a first path P1 may be blocked by the first support portion 441 and thus not proceed outside the lens assembly 400 through the first body tube circumferential portion 411. Light refracted by the second lens 430 and proceeding along a second path P2 may be blocked by the first support portion 441 and thus not proceed outside the lens assembly 400 through the first body tube circumferential portion 411.

Referring to FIG. 8B, the lens assembly 400 may include the second circumferential portion 402. The second body tube circumferential portion 412, second lens circumferential portions 422, 432, 472, and 482, and second support portions 442 and 492 may be disposed in the second circumferential portion 402. The first lens 420 may include the (1-2)^{th} lens circumferential portion 422. The (1-2)^{th} lens circumferential portion 422 may be referred to as the “second lens circumferential portion”. The second lens 430 may include a (2-2)^{th} lens circumferential portion 432. The third lens 470 may include a (3-2)^{th} lens circumferential portion 472. The fourth lens 480 may include a (4-2)^{th} lens circumferential portion 482. The description of the second lens circumferential portion 422 may be applied to a description of the (2-2)^{th} lens circumferential portion 432, the (3-2)^{th} lens circumferential portion 472, and the (4-2)^{th} lens circumferential portion 482. The second lens circumferential portion 422 may be a portion of the lens 420 located in the second circumferential portion 402 of the lens assembly 400. The first support member 440 may include a (1-2)^{th} support portion 442. The (1-2)^{th} support portion 442 may be referred to as the “second support portion”. The second support member 490 may include a (2-2)^{th} support portion 492. The description of the second support portion 442 may be applied equally to the (2-2)^{th} support portion 492. The second support portion 442 may be a portion of the support member 440 located in the second circumferential portion 402 of the lens assembly 400.

According to an embodiment, the second lens circumferential portion 422 may be spaced apart from the second support portion 442. The shielding member 450 may be disposed between the second lens circumferential portion 422 and the second support portion 442. The shielding member 450 may shield a space between the second lens circumferential portion 422 and the second support portion 442. The shielding member 450 may be referred to as a “light-blocking member”. The shielding member 450 may be referred to as a “finishing member”. Light passing through the lenses 420 and 430 may be blocked by the shielding member 450. Light refracted by the first lens 420 and proceeding along a third path P3 may be blocked by the shielding member 450 and thus not proceed outside the lens assembly 400 through the second body tube circumferential portion 412. Light refracted by the second lens 430 and proceeding along a fourth path P4 may be blocked by the shielding member 450 and thus not proceed outside the lens assembly 400 through the second body tube circumferential portion 412. The shielding member 450 may seal a space between the lens 420 and the support member 440. The shielding member 450 may be formed of a rubber or ceramic material.

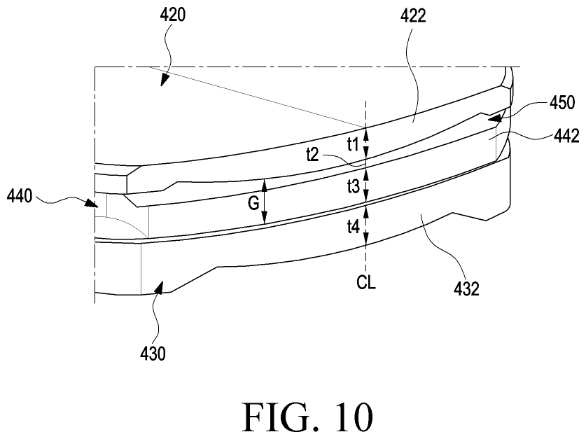

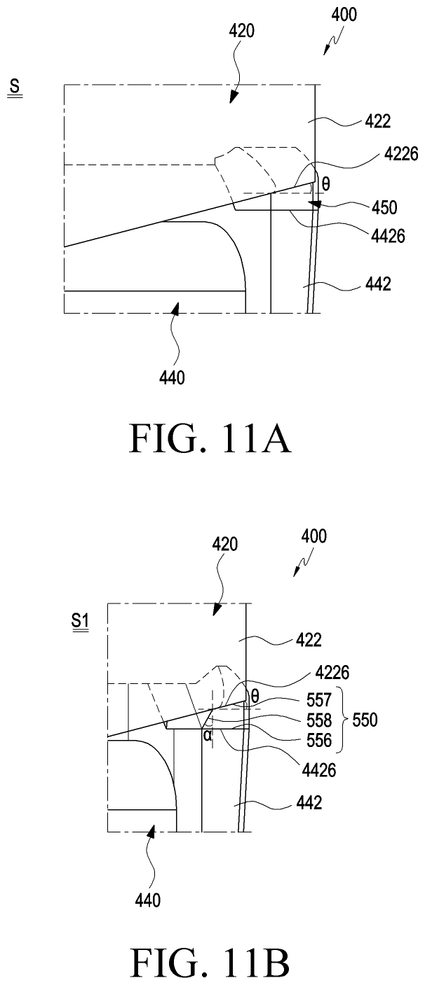

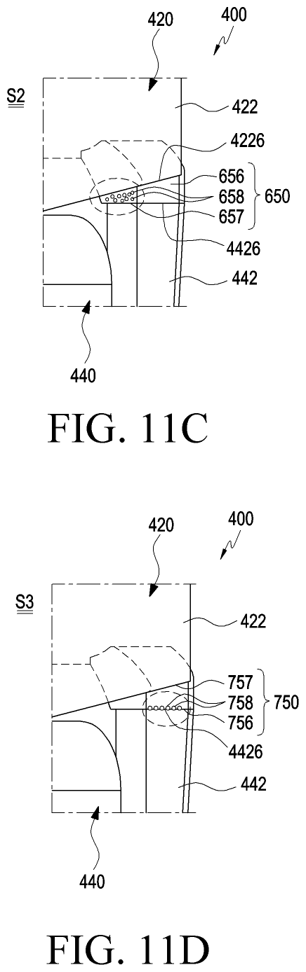

FIG. 9A is a diagram illustrating a coupled state between the lens 420 and the support member 440, before the shielding member 450 is disposed according to an embodiment of the disclosure. FIG. 9B is a diagram illustrating a coupled state between the lens 420 and the support member 440, after the shielding member 450 is disposed according to an embodiment of the disclosure. FIG. 10 is an enlarged view illustrating a portion of FIG. 9B according to an embodiment of the disclosure. FIG. 10 may illustrate a state where the second lens 430 is additionally disposed in the structure of FIG. 9B. The components described with reference to FIGS. 9A, 9B, and 10 may be partially or entirely the same as the components described with reference to FIGS. 1 to 5, 6A, 6B, 7, 8A, and 8B. The components described with reference to FIGS. 9A, 9B, and 10 may be partially or entirely the same as the components described with reference to FIGS. 11A to 11D, 12A to 12C, and 13.

Referring to FIGS. 9A, 9B, and 10, according to an embodiment, a lens 420 may include a first lens circumferential portion 421 and a second lens circumferential portion 422. The support member 440 may include the first support portion 441 and the second support portion 442. The first lens circumferential portion 421 may be coupled to the first support portion 441. The first lens circumferential portion 421 may be seated on the first support portion 441 and contact the first support portion 441. The second lens circumferential portion 422 may be spaced apart from the second support portion 442. A gap 405 may be formed between the second lens circumferential portion 422 and the second support portion 442.

According to an embodiment, the second lens circumferential portion 422 may include a first bending portion 4221. The first bending portion 4221 may be connected to the first lens circumferential portion 421. The first bending portion 4221 may be bent from the first lens circumferential portion 421. The second lens circumferential portion 422 may include a second bending portion 4222. The second bending portion 4222 may be connected to the first lens circumferential portion 421. The second bending portion 4222 may be bent from the first lens circumferential portion 421. The first bending portion 4221 and the second bending portion 4222 may be spaced apart from each other. The second lens circumferential portion 422 may include an extending portion 4223. The extending portion 4223 may connect the first bending portion 4221 and the second bending portion 4222. The extending portion 4223 may be formed convexly toward the support member 440. The second lens circumferential portion 422 may include a first recess 4224. The first recess 4224 may be formed in a connection portion between the first bending portion 4221 and the extending portion 4223. The first recess 4224 may be recessed in a direction away from the support member 440. The second lens circumferential portion 422 may include a second recess 4225. The second recess 4225 may be formed in a connection portion between the second bending portion 4222 and the extending portion 4223. The second recess 4225 may extend in the direction away from the support member 440.

According to an embodiment, the second support portion 442 may include a first stepped portion 4421. The first stepped portion 4421 may be formed in a position corresponding to the first bending portion 4221. The first stepped portion 4421 may be spaced apart from the first bending portion 4221. The first stepped portion 4421 may be connected to the first support portion 441. The second support portion 442 may include a second stepped portion 4422. The second stepped portion 4422 may be formed in a position corresponding to the second bending portion 4222. The second stepped portion 4422 may be spaced apart from the second bending portion 4222. The second stepped portion 4422 may be connected to the first support portion 441. The second support portion 442 may include a support frame 4423. The support frame 4423 may connect the first stepped portion 4421 and the second stepped portion 4422. The support frame 4423 may be formed in a position corresponding to the extending portion 4223. The support frame 4423 may be spaced apart from the extending portion 4223.

According to an embodiment, the shielding member 450 may be disposed in the gap (G) 405 formed between the lens 420 and the support member 440. The shielding member 450 may be disposed between the second lens circumferential portion 422 and the second support portion 442.

According to an embodiment, the shielding member 450 may include a first finishing portion 451. The first finishing portion 451 may be disposed between the first bending portion 4221 and the first stepped portion 4421. At least a portion of the first finishing portion 451 may be inserted into the first recess 4224. The shielding member 450 may include a second finishing portion 452. The second finishing portion 452 may be disposed between the second bending portion 4222 and the second stepped portion 4422. At least a portion of the second finishing portion 452 may be inserted into the second recess 4225. The shielding member 450 may include a third finishing portion 453. The third finishing portion 453 may be disposed between the extending portion 4223 and the support frame 4423.

According to an embodiment, the support member 440 may be disposed between the first lens 420 and the second lens 430. The second support portion 442 may be disposed between the second lens circumferential portion 422 of the first lens 420 and the second lens circumferential portion 432 of the second lens 430.

According to an embodiment, a thickness t2 of the shielding member 450 may be smaller than a thickness t1 of the first lens 420. The thickness t2 of the shielding member 450 may be smaller than a thickness t3 of the support member 440. The thickness t2 of the shielding member 450 may be smaller than a thickness t4 of the second lens 430. For example, the extending portion 4223 of the second lens circumferential portion 422 may be formed convexly toward the support member 440, and a center line CL passing through a vertex of the extending portion 4223 may be formed. According to an embodiment, the thickness t2 of the shielding member 450 may be smaller than the thickness t1 of the first lens 420 on the center line CL. The thickness t2 of the shielding member 450 may be smaller than the thickness t3 of the support member 440 on the center line CL.

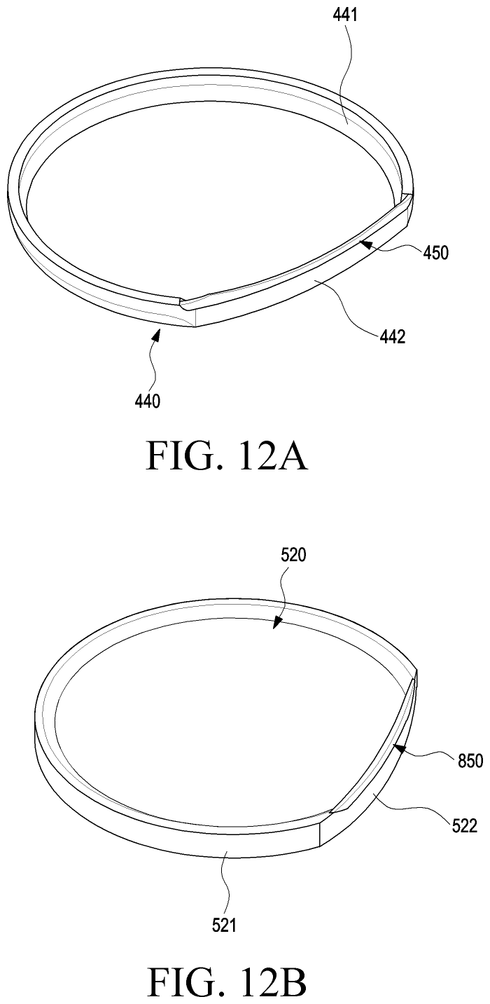

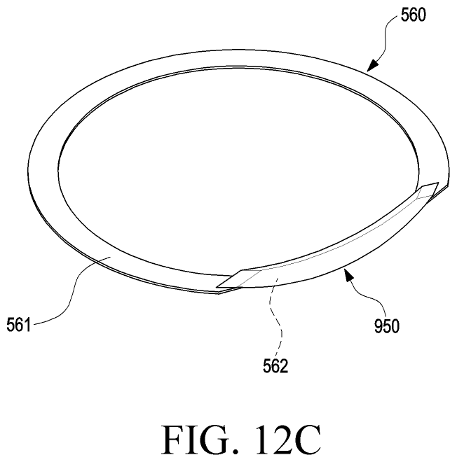

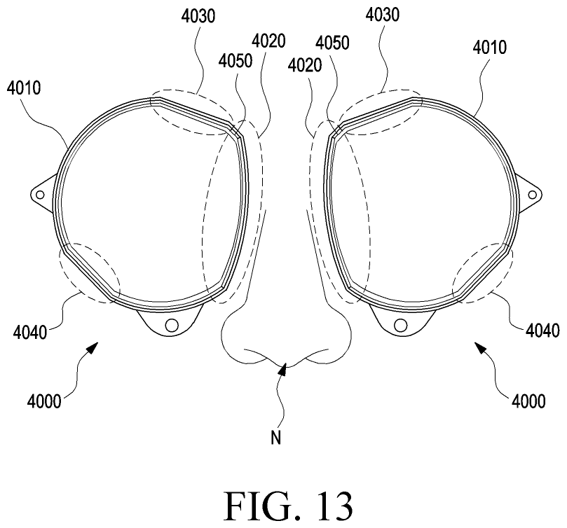

FIG. 11A is an enlarged projection view illustrating a region S illustrated in FIG. 8B according to an embodiment of the disclosure. FIG. 11B is an enlarged projection view illustrating a region S1 corresponding to the region S illustrated in FIG. 8B according to an embodiment of the disclosure. FIG. 11C is an enlarged projection view illustrating a region S2 corresponding to the region S illustrated in FIG. 8B according to an embodiment of the disclosure. FIG. 11D is an enlarged projection view illustrating a region S3 corresponding to the region S illustrated in FIG. 8B according to an embodiment of the disclosure. The components described with reference to FIGS. 11A to 11D may be partially or entirely the same as the components described with reference to FIGS. 1 to 5, 6A, 6B, 7, 8A, 8B, 9A, 9B, and 10. The components described with reference to FIGS. 11A to 11D may be partially or entirely the same as the components described with reference to FIGS. 12A to 12C, and 13.

Referring to FIG. 11A, a shielding member 450 may be disposed between a lens 420 and a support member 440. The shielding member 450 may be disposed between the second lens circumferential portion 422 and the second support portion 442. The second lens circumferential portion 422 may include a lens surface 4226. The lens surface 4226 may be spaced apart from the second support portion 442. The lens surface 4226 may be inclined toward the outside of the lens assembly 400 in a direction away from the support member 440. The lens surface 4226 may have an inclination angle θ. The second support portion 442 may include a support surface 4426. The support surface 4426 may be spaced apart from the lens surface 4226. The shielding member 450 may be disposed between the lens surface 4226 and the support surface 4426. The shielding member 450 may be in contact with each of the lens surface 4226 and the support surface 4426.

Referring to FIG. 11B, the second lens circumferential portion 422 may include the lens surface 4226 having the inclination angle θ, and the second support portion 442 may include the support surface 4426 spaced apart from the lens surface 4226. A shielding member 550 may be disposed between the lens surface 4226 and the support surface 4426. The thickness of the shielding member 550 between the lens surface 4226 and the support surface 4426 may be variable along the direction toward the outside of the lens assembly 400. The shielding member 550 may include a first finishing surface 556 contacting the support surface 4426, a second finishing surface 557 contacting the lens surface 4226, and a third finishing surface 558 connecting the first finishing surface 556 and the second finishing surface 557. The third finishing surface 558 may be inclined with respect to the direction in which the lens surface 4226 and the support surface 4426 are spaced apart from each other. The third finishing surface 558 may have an inclination angle α. Due to the structure described above, an optical area inside the lens assembly 400 may be increased.

Referring to FIG. 11C, a shielding member 650 may be disposed between the second lens circumferential portion 422 and the second support portion 442. The shielding member 650 may include a first portion 656 located between the lens surface 4226 and the support surface 4426 and a second portion 657 protruding toward the inside of the lens assembly 400 from the first portion 656. The shielding member 650 may include a buffer member 658. The buffer member 658 may be disposed in the second portion 657. The buffer member 658 may have an emboss structure. Due to the structure described above, light scattering may be reduced.

Referring to FIG. 11D, a shielding member 750 may be disposed between the second lens circumferential portion 422 and the second support portion 442. The shielding member 750 may include a first finishing surface 756 contacting the support surface 4426 and a second finishing surface 757 contacting the second lens circumferential portion 422. The shielding member 750 may include an adhesive member 758. The adhesive member 758 may be disposed between the first finishing surface 756 and the support surface 4426. The adhesive member 758 may be a bonding material coated on the first finishing surface 756. The adhesive member 758 may be a bonding material coated on the support surface 4426. Due to the structure described above, a binding force between the shielding member 750 and the support member 440 may be strengthened.

FIG. 12A is a perspective view illustrating the support member 440 according to an embodiment of the disclosure. FIG. 12B is a perspective view illustrating a lens 520 according to an embodiment of the disclosure. FIG. 12C is a perspective view illustrating a film 560 according to an embodiment of the disclosure. The components described with reference to FIGS. 12A to 12C may be partially or entirely the same as the components described with reference to FIGS. 1 to 5, 6A, 6B, 7, 8A, 8B, 9A, 9B, 10, and 11A to 11D. The components described with reference to FIGS. 12A to 12C may be partially or entirely the same as the components described with reference to FIG. 13.

Referring to FIG. 12A, a shielding member 450 may be integrally formed with a support member 440. The shielding member 450 may be integrally formed with the second support portion 442 and connected to the first support portion 441.

Referring to FIG. 12B, a shielding member 850 may be integrally formed with a lens 520. The description of the lens 420 with reference to FIGS. 1 to 5, 6A, 6B, 7, 8A, 8B, 9A, 9B, 10, and 11A to 11D may be applied equally to the lens 520. The description of the shielding member 450 with reference to FIGS. 1 to 5, 6A, 6B, 7, 8A, 8B, 9A, 9B, 10, and 11A to 11D may be applied equally to the shielding member 850. The shielding member 850 may be integrally formed with a second lens circumferential portion 522 of the lens 520 and connected to a first lens circumferential portion 521.

Referring to FIG. 12C, a shielding member 950 may be integrally formed with a film 560. The description of the film 460 with reference to FIG. 7 may be applied equally to the film 560. The description of the shielding member 450 with reference to FIGS. 1 to 5, 6A, 6B, 7, 8A, 8B, 9A, 9B, 10, and 11A to 11D may be applied equally to the shielding member 950. The shielding member 950 may be integrally formed with a second film circumferential portion 562 of the film 560 and connected to a first film circumferential portion 561.

FIG. 13 is a diagram selectively illustrating a lens assembly and a user's nose N, while the user wears a wearable electronic device (e.g., the wearable electronic device 300 of FIG. 4) according to an embodiment of the disclosure. The components described with reference to FIG. 13 may be partially or entirely the same as the components described with reference to FIGS. 1 to 5, 6A, 6B, 7, 8A, 8B, 9A, 9B, 10, and 11A to 11D, and 12A to 12C.

Referring to FIG. 13, according to an embodiment, a lens assembly 4000 may include a first circumferential portion 4010 and a second circumferential portion 4020. The description of the first circumferential portion 401 and the second circumferential portion 402 with reference to FIGS. 1 to 5, 6A, 6B, 7, 8A, 8B, 9A, 9B, 10, and 11A to 11D, and 12A to 12C may be applied equally to the first circumferential portion 4010 and the second circumferential portion 4020.

According to an embodiment, the lens assembly 4000 may include a third circumferential portion 4030. The third circumferential portion 4030 may be spaced apart from the second circumferential portion 4020. A connecting portion 4050 may be formed between the second circumferential portion 4020 and the third circumferential portion 4030. The connecting portion 4050 may be formed to be curved. In the wearable electronic device according to an embodiment of the disclosure, the second circumferential portion 4020 and the third circumferential portion 4030 may contact each other. In the wearable electronic device according to an embodiment of the disclosure, the second circumferential portion 4020 and the third circumferential portion 4030 may be directly connected. A curvature of the third circumferential portion 4030 may be smaller than a curvature of the first circumferential portion 4010. The third circumferential portion 4030 may be formed by cutting off a portion of the disk-shaped lens assembly 4000. The third circumferential portion 4030 may be a portion facing the user's body part. For example, the third circumferential portion 4030 may be a portion facing the user's glabella. The lens assembly 4000 may include a fourth circumferential portion 4040. The fourth circumferential portion 4040 may be spaced apart from the second and third circumferential portions 4020 and 4030. The fourth circumferential portion 4040 may be formed by cutting off a portion of the disk-shaped lens assembly 4000. The fourth circumferential portion 4040 may be a portion facing the user's body part. For example, the fourth circumferential portion 4040 may be a portion facing the user's cheekbone.

A wearable electronic device may be worn on a user's body. The wearable electronic device that provides display information to the user's eyes may be worn on the user's face and include a lens assembly corresponding to the user's eyes. The lens assembly needs to be expanded to a certain size or more for providing display information, and may interfere with the user's body part.

An object to be achieved in the disclosure may be to provide a wearable electronic device with reduced interference with the human body.

An object to be achieved in the disclosure may be to reduce the amount of light leaking out of a lens assembly.

The objects to be achieved in the disclosure are not limited to the objects mentioned above and may be variously expanded without departing from the spirit and scope of the disclosure.

In an electronic device according to various embodiments of the disclosure, a lens assembly has a first circumferential portion and a second circumferential portion with different curvatures, thereby reducing interference between a lens assembly and a user's body part.

In an electronic device according to various embodiments of the disclosure, a shielding member is disposed between a lens and a support member, thereby reducing the amount of light leaking out of a lens assembly.

The effects obtainable in the disclosure are not limited to the effects mentioned above, and other effects not mentioned will be clearly understood by those skilled in the art from the description below without departing from the spirit and scope of the disclosure.

According to an embodiment of the disclosure, a wearable electronic device (e.g., 101, 200, and 300 in FIGS. 1 to 5, 6A, 6B, 7, 8A, 8B, 9A, 9B, 10, and 11A to 11D, and 12A to 12C, and 13) may include a display (e.g., 201 in FIGS. 1 to 5, 6A, 6B, 7, 8A, 8B, 9A, 9B, 10, and 11A to 11D, 12A to 12C, and 13) configured to output visual information.

According to an embodiment of the disclosure, the wearable electronic device (e.g., 101, 200, and 300 in FIGS. 1 to 5, 6A, 6B, 7, 8A, 8B, 9A, 9B, 10, and 11A to 11D, 12A to 12C, and 13) may include a lens assembly (e.g., 400 in FIGS. 1 to 5, 6A, 6B, 7, 8A, 8B, 9A, 9B, 10, and 11A to 11D, 12A to 12C, and 13) configured to allow the visual information output from the display (e.g., 201 in FIGS. 1 to 5, 6A, 6B, 7, 8A, 8B, 9A, 9B, 10, and 11A to 11D, 12A to 12C, and 13) to pass through.

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a body tube (e.g., 410 in FIGS. 1 to 5, 6A, 6B, 7, 8A, 8B, 9A, 9B, 10, 11A to 11D, 12A to 12C, and 13) forming a space therein.

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a first lens (e.g., 420 in FIGS. 1 to 5, 6A, 6B, 7, 8A, 8B, 9A, 9B, 10, 11A to 11D, 12A to 12C, and 13) including a first lens circumferential portion (e.g., 421 in FIGS. 1 to 5, 6A, 6B, 7, 8A, 8B, 9A, 9B, 10, 11A to 11D, 12A to 12C, and 13) at least partially extending along a circumferential direction of the body tube (e.g., 410 in FIGS. 1 to 5, 6A, 6B, 7, 8A, 8B, 9A, 9B, 10, 11A to 11D, 12A to 12C, and 13) and a second lens circumferential portion (e.g., 422 in FIGS. 1 to 5, 6A, 6B, 7, 8A, 8B, 9A, 9B, 10, 11A to 11D, 12A to 12C, and 13) connected to the first lens circumferential portion (e.g., 421 in FIGS. 1 to 5, 6A, 6B, 7, 8A, 8B, 9A, 9B, 10, 11A to 11D, 12A to 12C, and 13) and forming a bending portion (e.g., 4221 and 4222 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a second lens (e.g., 430 in FIGS. 1 to 5, 6A, 6B, 7, 8A, 8B, 9A, 9B, 10, 11A to 11D, 12A to 12C, and 13) disposed inside the body tube (e.g., 410 in FIGS. 1 to 5, 6A, 6B, 7, 8A, 8B, 9A, 9B, 10, 11A to 11D, 12A to 12C, and 13) and spaced apart from the first lens (e.g., 420 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a support member (e.g., 440 in FIGS. 1 to 5, 6A, 6B, 7, 8A, 8B, 9A, 9B, 10, 11A to 11D, 12A to 12C, and 13) disposed between the first lens (e.g., 420 in FIGS. 1 to 5, 6A, 6B, 7, 8A, 8B, 9A, 9B, 10, 11A to 11D, 12A to 12C, and 13) and the second lens (e.g., 430 in FIGS. 1 to 5, 6A, 6B, 7, 8A, 8B, 9A, 9B, 10, 11A to 11D, 12A to 12C, and 13), and including a first support portion (e.g., 441 in FIGS. 1 to 5, 6A, 6B, 7, 8A, 8B, 9A, 9B, 10, 11A to 11D, 12A to 12C, and 13) extending along the first lens circumferential portion (e.g., 421 in FIGS. 1 to 5, 6A, 6B, 7, 8A, 8B, 9A, 9B, 10, 11A to 11D, 12A to 12C, and 13) and a second support portion (e.g., 442 in FIGS. 1 to 5, 6A, 6B, 7, 8A, 8B, 9A, 9B, 10, 11A to 11D, 12A to 12C, and 13) corresponding to the second lens circumferential portion (e.g., 422 in FIGS. 1 to 5, 6A, 6B, 7, 8A, 8B, 9A, 9B, 10, 11A to 11D, 12A to 12C, and 13) and spaced apart from the second lens circumferential portion (e.g., 422 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a shielding member (e.g., 450 in FIGS. 1 to 5, 6A, 6B, 7, 8A, 8B, 9A, 9B, 10, 11A to 11D, 12A to 12C, and 13) disposed between the second lens circumferential portion (e.g., 422 in FIGS. 1 to 5, 6A, 6B, 7, 8A, 8B, 9A, 9B, 10, 11A to 11D, 12A to 12C, and 13) and the second support portion (e.g., 442 in FIGS. 1 to 5, 6A, 6B, 7, 8A, 8B, 9A, 9B, 10, 11A to 11D, 12A to 12C, and 13).

According to an embodiment of the disclosure, a curvature of the first lens circumferential portion (e.g., 421 in FIGS. 1 to 5, 6A, 6B, 7, 8A, 8B, 9A, 9B, 10, 11A to 11D, 12A to 12C, and 13) is greater than a curvature of the second lens circumferential portion (e.g., 422 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a first circumferential portion (e.g., 401 in FIGS. 1 to 5, 6A, 6B, 7, 8A, 8B, 9A, 9B, 10, 11A to 11D, 12A to 12C, and 13) corresponding to the first lens circumferential portion (e.g., 421 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a second circumferential portion (e.g., 402 in FIGS. 1 to 5, 6A, 6B, 7, 8A, 8B, 9A, 9B, 10, 11A to 11D, 12A to 12C, and 13) corresponding to the second lens circumferential portion (e.g., 422 in FIGS. 1 to 5, 6A, 6B, 7, 8A, 8B, 9A, 9B, 10, 11A to 11D, 12A to 12C, and 13).

According to an embodiment of the disclosure, the body tube (e.g., 410 in FIGS. 1 to 5, 6A, 6B, 7, 8A, 8B, 9A, 9B, 10, 11A to 11D, 12A to 12C, and 13) may include a first body tube circumferential portion (e.g., 411 in FIGS. 1 to 5, 6A, 6B, 7, 8A, 8B, 9A, 9B, 10, 11A to 11D, 12A to 12C, and 13) surrounding the first lens circumferential portion (e.g., 421 in FIGS. 1 to 5, 6A, 6B, 7, 8A, 8B, 9A, 9B, 10, 11A to 11D, 12A to 12C, and 13).

According to an embodiment of the disclosure, the body tube (e.g., 410 in FIGS. 1 to 5, 6A, 6B, 7, 8A, 8B, 9A, 9B, 10, 11A to 11D, 12A to 12C, and 13) may include a second body tube circumferential portion (e.g., 412 in FIGS. 1 to 5, 6A, 6B, 7, 8A, 8B, 9A, 9B, 10, 11A to 11D, 12A to 12C, and 13) surrounding the second lens circumferential portion (e.g., 422 in FIGS. 1 to 5, 6A, 6B, 7, 8A, 8B, 9A, 9B, 10, 11A to 11D, 12A to 12C, and 13).

According to an embodiment of the disclosure, the bending portion (e.g., 4221 and 4222 in FIGS. 1 to 5, 6A, 6B, 7, 8A, 8B, 9A, 9B, 10, 11A to 11D, 12A to 12C, and 13) may include a first bending portion (e.g., 4221 in FIGS. 1 to 5, 6A, 6B, 7, 8A, 8B, 9A, 9B, 10, 11A to 11D, 12A to 12C, and 13) connected to the first lens circumferential portion (e.g., 421 in FIGS. 1 to 5, 6A, 6B, 7, 8A, 8B, 9A, 9B, 10, 11A to 11D, 12A to 12C, and 13).

According to an embodiment of the disclosure, the bending portion (e.g., 4221 and 4222 in FIGS. 1 to 5, 6A, 6B, 7, 8A, 8B, 9A, 9B, 10, 11A to 11D, 12A to 12C, and 13) may include a second bending portion (e.g., 4222 in FIGS. 1 to 5, 6A, 6B, 7, 8A, 8B, 9A, 9B, 10, 11A to 11D, 12A to 12C, and 13) connected to the first lens circumferential portion (e.g., 421 in FIGS. 1 to 5, 6A, 6B, 7, 8A, 8B, 9A, 9B, 10, 11A to 11D, 12A to 12C, and 13) and spaced apart from the first bending portion (e.g., 4221 in FIGS. 1 to 5, 6A, 6B, 7, 8A, 8B, 9A, 9B, 10, 11A to 11D, 12A to 12C, and 13).

According to an embodiment of the disclosure, the second lens circumferential portion (e.g., 422 in FIGS. 1 to 5, 6A, 6B, 7, 8A, 8B, 9A, 9B, 10, 11A to 11D, 12A to 12C, and 13) may include an extending portion (e.g., 4223 in FIGS. 1 to 5, 6A, 6B, 7, 8A, 8B, 9A, 9B, 10, 11A to 11D, 12A to 12C, and 13) formed convexly toward the support member (e.g., 440 in FIGS. 1 to 5, 6A, 6B, 7, 8A, 8B, 9A, 9B, 10, 11A to 11D, 12A to 12C, and 13).

According to an embodiment of the disclosure, the second lens circumferential portion (e.g., 422 in FIGS. 1 to 5, 6A, 6B, 7, 8A, 8B, 9A, 9B, 10, 11A to 11D, 12A to 12C, and 13) may include a first recess (e.g., 4224 in FIGS. 1 to 5, 6A, 6B, 7, 8A, 8B, 9A, 9B, 10, 11A to 11D, 12A to 12C, and 13) formed in a direction away from the support member (e.g., 440 in FIGS. 1 to 5, 6A, 6B, 7, 8A, 8B, 9A, 9B, 10, 11A to 11D, 12A to 12C, and 13).

According to an embodiment of the disclosure, the second lens circumferential portion (e.g., 422 in FIGS. 1 to 5, 6A, 6B, 7, 8A, 8B, 9A, 9B, 10, 11A to 11D, 12A to 12C, and 13) may include a second recess (e.g., 4225 in FIGS. 1 to 5, 6A, 6B, 7, 8A, 8B, 9A, 9B, 10, 11A to 11D, 12A to 12C, and 13) formed in a direction away from the support member (e.g., 440 in FIGS. 1 to 5, 6A, 6B, 7, 8A, 8B, 9A, 9B, 10, 11A to 11D, 12A to 12C, and 13) and spaced apart from the first recess (e.g., 4224 in FIGS. 1 to 5, 6A, 6B, 7, 8A, 8B, 9A, 9B, 10, 11A to 11D, 12A to 12C, and 13).

According to an embodiment of the disclosure, the second support portion (e.g., 442 in FIGS. 1 to 5, 6A, 6B, 7, 8A, 8B, 9A, 9B, 10, 11A to 11D, 12A to 12C, and 13) may include a first stepped portion (e.g., 4421 in FIGS. 1 to 5, 6A, 6B, 7, 8A, 8B, 9A, 9B, 10, 11A to 11D, 12A to 12C, and 13) connected to the first support portion (e.g., 441 in FIGS. 1 to 5, 6A, 6B, 7, 8A, 8B, 9A, 9B, 10, 11A to 11D, 12A to 12C, and 13).

According to an embodiment of the disclosure, the second support portion (e.g., 442 in FIGS. 1 to 5, 6A, 6B, 7, 8A, 8B, 9A, 9B, 10, 11A to 11D, 12A to 12C, and 13) may include a second stepped portion (e.g., 4422 in FIGS. 1 to 5, 6A, 6B, 7, 8A, 8B, 9A, 9B, 10, 11A to 11D, 12A to 12C, and 13) connected to the first support portion (e.g., 441 in FIGS. 1 to 5, 6A, 6B, 7, 8A, 8B, 9A, 9B, 10, 11A to 11D, 12A to 12C, and 13) and spaced apart from the first stepped portion (e.g., 4421 in FIGS. 1 to 5, 6A, 6B, 7, 8A, 8B, 9A, 9B, 10, 11A to 11D, 12A to 12C, and 13).

According to an embodiment of the disclosure, the second support portion (e.g., 442 in FIGS. 1 to 5, 6A, 6B, 7, 8A, 8B, 9A, 9B, 10, 11A to 11D, 12A to 12C, and 13) may include a support frame (e.g., 4423 in FIGS. 1 to 5, 6A, 6B, 7, 8A, 8B, 9A, 9B, 10, 11A to 11D, 12A to 12C, and 13) spaced apart from the second circumferential portion (e.g., 422 in FIGS. 1 to 5, 6A, 6B, 7, 8A, 8B, 9A, 9B, 10, 11A to 11D, 12A to 12C, and 13) and forming a gap (e.g., 405 in FIGS. 1 to 5, 6A, 6B, 7, 8A, 8B, 9A, 9B, 10, 11A to 11D, 12A to 12C, and 13) between the support frame (e.g., 4423 in FIGS. 1 to 5, 6A, 6B, 7, 8A, 8B, 9A, 9B, 10, 11A to 11D, 12A to 12C, and 13) and the second lens circumferential portion (e.g., 422 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 450 in FIGS. 1 to 5, 6A, 6B, 7, 8A, 8B, 9A, 9B, 10, 11A to 11D, 12A to 12C, and 13) may include a first finishing portion (e.g., 451 in FIGS. 1 to 5, 6A, 6B, 7, 8A, 8B, 9A, 9B, 10, 11A to 11D, 12A to 12C, and 13) disposed in a position in which the first lens circumferential portion (e.g., 421 in FIGS. 1 to 5, 6A, 6B, 7, 8A, 8B, 9A, 9B, 10, 11A to 11D, 12A to 12C, and 13) and the second lens circumferential portion (e.g., 422 in FIGS. 1 to 5, 6A, 6B, 7, 8A, 8B, 9A, 9B, 10, 11A to 11D, 12A to 12C, and 13) are connected.

According to an embodiment of the disclosure, the shielding member (e.g., 450 in FIGS. 1 to 5, 6A, 6B, 7, 8A, 8B, 9A, 9B, 10, 11A to 11D, 12A to 12C, and 13) may include a second finishing portion (e.g., 452 in FIGS. 1 to 5, 6A, 6B, 7, 8A, 8B, 9A, 9B, 10, 11A to 11D, 12A to 12C, and 13) disposed in a position in which the first lens circumferential portion (e.g., 421 in FIGS. 1 to 5, 6A, 6B, 7, 8A, 8B, 9A, 9B, 10, 11A to 11D, 12A to 12C, and 13) and the second lens circumferential portion (e.g., 422 in FIGS. 1 to 5, 6A, 6B, 7, 8A, 8B, 9A, 9B, 10, 11A to 11D, 12A to 12C, and 13) are connected, and spaced apart from the first finishing portion (e.g., 451 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 450 in FIGS. 1 to 5, 6A, 6B, 7, 8A, 8B, 9A, 9B, 10, 11A to 11D, 12A to 12C, and 13) may include a third finishing portion (e.g., 453 in FIGS. 1 to 5, 6A, 6B, 7, 8A, 8B, 9A, 9B, 10, 11A to 11D, 12A to 12C, and 13) connecting the first finishing portion (e.g., 451 in FIGS. 1 to 5, 6A, 6B, 7, 8A, 8B, 9A, 9B, 10, 11A to 11D, 12A to 12C, and 13) and the second finishing portion (e.g., 452 in FIGS. 1 to 5, 6A, 6B, 7, 8A, 8B, 9A, 9B, 10, 11A to 11D, 12A to 12C, and 13).

According to an embodiment of the disclosure, the second lens circumferential portion (e.g., 422 in FIGS. 1 to 5, 6A, 6B, 7, 8A, 8B, 9A, 9B, 10, 11A to 11D, 12A to 12C, and 13) may include a lens surface (e.g., 4226 in FIGS. 1 to 5, 6A, 6B, 7, 8A, 8B, 9A, 9B, 10, 11A to 11D, 12A to 12C, and 13) inclined toward an outside of the lens assembly (e.g., 400 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 450 in FIGS. 1 to 5, 6A, 6B, 7, 8A, 8B, 9A, 9B, 10, 11A to 11D, 12A to 12C, and 13) may contact the lens surface (e.g., 4226 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 550 in FIGS. 1 to 5, 6A, 6B, 7, 8A, 8B, 9A, 9B, 10, 11A to 11D, 12A to 12C, and 13) may include a first finishing surface (e.g., 556 in FIGS. 1 to 5, 6A, 6B, 7, 8A, 8B, 9A, 9B, 10, 11A to 11D, 12A to 12C, and 13) in contact with the second support portion (e.g., 442 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 550 in FIGS. 1 to 5, 6A, 6B, 7, 8A, 8B, 9A, 9B, 10, 11A to 11D, 12A to 12C, and 13) may include a second finishing surface (e.g., 557 in FIGS. 1 to 5, 6A, 6B, 7, 8A, 8B, 9A, 9B, 10, 11A to 11D, 12A to 12C, and 13) in contact with the second lens circumferential portion (e.g., 422 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 550 in FIGS. 1 to 5, 6A, 6B, 7, 8A, 8B, 9A, 9B, 10, 11A to 11D, 12A to 12C, and 13) may include a third finishing surface (e.g., 558 in FIGS. 1 to 13) connecting the first finishing surface (e.g., 556 in FIGS. 1 to 5, 6A, 6B, 7, 8A, 8B, 9A, 9B, 10, 11A to 11D, 12A to 12C, and 13) and the second finishing surface (e.g., 557 in FIGS. 1 to 5, 6A, 6B, 7, 8A, 8B, 9A, 9B, 10, 11A to 11D, 12A to 12C, and 13) and inclined toward an inside of the lens assembly (e.g., 400 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 550 in FIGS. 1 to 5, 6A, 6B, 7, 8A, 8B, 9A, 9B, 10, 11A to 11D, 12A to 12C, and 13) may include a first portion (e.g., 656 in FIGS. 1 to 5, 6A, 6B, 7, 8A, 8B, 9A, 9B, 10, 11A to 11D, 12A to 12C, and 13) disposed between the second lens circumferential portion (e.g., 422 in FIGS. 1 to 5, 6A, 6B, 7, 8A, 8B, 9A, 9B, 10, 11A to 11D, 12A to 12C, and 5, 6A, 6B, 7, 8A, 8B, 9A, 9B, 10, 11A to 11D, 12A to 12C, and 13) and the second support portion (e.g., 442 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 550 in FIGS. 1 to 5, 6A, 6B, 7, 8A, 8B, 9A, 9B, 10, 11A to 11D, 12A to 12C, and 13) may include a second portion (e.g., 657 in FIGS. 1 to 5, 6A, 6B, 7, 8A, 8B, 9A, 9B, 10, 11A to 11D, 12A to 12C, and 13) protruding from the first portion (e.g., 656 in FIGS. 1 to 5, 6A, 6B, 7, 8A, 8B, 9A, 9B, 10, 11A to 11D, 12A to 12C, and 13) toward the inside of the lens assembly (e.g., 400 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 550 in FIGS. 1 to 5, 6A, 6B, 7, 8A, 8B, 9A, 9B, 10, 11A to 11D, 12A to 12C, and 13) may include a buffer member (e.g., 658 in FIGS. 1 to 5, 6A, 6B, 7, 8A, 8B, 9A, 9B, 10, 11A to 11D, 12A to 12C, and 13) disposed in the second portion (e.g., 657 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may further include an adhesive member (e.g., 758 in FIGS. 1 to 5, 6A, 6B, 7, 8A, 8B, 9A, 9B, 10, 11A to 11D, 12A to 12C, and 13) disposed between the shielding member (e.g., 750 in FIGS. 1 to 5, 6A, 6B, 7, 8A, 8B, 9A, 9B, 10, 11A to 11D, 12A to 12C, and 13) and the second support portion (e.g., 442 in FIGS. 1 to 5, 6A, 6B, 7, 8A, 8B, 9A, 9B, 10, 11A to 11D, 12A to 12C, and 13).

According to an embodiment of the disclosure, the shielding member (e.g., 450 in FIGS. 1 to 5, 6A, 6B, 7, 8A, 8B, 9A, 9B, 10, 11A to 11D, 12A to 12C, and 13) may be formed integrally with the support member (e.g., 440 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may be configured to allow the visual information output from the display (e.g., 201 in FIGS. 1 to 5, 6A, 6B, 7, 8A, 8B, 9A, 9B, 10, 11A to 11D, 12A to 12C, and 13) to pass through, and include a first circumferential portion (e.g., 401 in FIGS. 1 to 5, 6A, 6B, 7, 8A, 8B, 9A, 9B, 10, 11A to 11D, 12A to 12C, and 13) and a second circumferential portion (e.g., 402 in FIGS. 1 to 5, 6A, 6B, 7, 8A, 8B, 9A, 9B, 10, 11A to 11D, 12A to 12C, and 13) having a smaller curvature than the first circumferential portion (e.g., 401 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a lens (e.g., 420 in FIGS. 1 to 5, 6A, 6B, 7, 8A, 8B, 9A, 9B, 10, 11A to 11D, 12A to 12C, and 13) including a first lens circumferential portion (e.g., 421 in FIGS. 1 to 5, 6A, 6B, 7, 8A, 8B, 9A, 9B, 10, 11A to 11D, 12A to 12C, and 13) corresponding to the first circumferential portion (e.g., 401 in FIGS. 1 to 5, 6A, 6B, 7, 8A, 8B, 9A, 9B, 10, 11A to 11D, 12A to 12C, and 13) and a second lens circumferential portion (e.g., 422 in FIGS. 1 to 5, 6A, 6B, 7, 8A, 8B, 9A, 9B, 10, 11A to 11D, 12A to 12C, and 13) corresponding to the second circumferential portion (e.g., 402 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a support member (e.g., 440 in FIGS. 1 to 5, 6A, 6B, 7, 8A, 8B, 9A, 9B, 10, 11A to 11D, 12A to 12C, and 13) including a first support portion (e.g., 441 in FIGS. 1 to 5, 6A, 6B, 7, 8A, 8B, 9A, 9B, 10, 11A to 11D, 12A to 12C, and 13) coupled to the first lens circumferential portion (e.g., 421 in FIGS. 1 to 5, 6A, 6B, 7, 8A, 8B, 9A, 9B, 10, 11A to 11D, 12A to 12C, and 13) and a second support portion (e.g., 442 in FIGS. 1 to 5, 6A, 6B, 7, 8A, 8B, 9A, 9B, 10, 11A to 11D, 12A to 12C, and 13) connected to the first support portion (e.g., 441 in FIGS. 1 to 5, 6A, 6B, 7, 8A, 8B, 9A, 9B, 10, 11A to 11D, 12A to 12C, and 13) and spaced apart from the second lens circumferential portion (e.g., 422 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, and 12A to 12C, and 13) may include a shielding member (e.g., 450 in FIGS. 1 to 5, 6A, 6B, 7, 8A, 8B, 9A, 9B, 10, 11A to 11D, 12A to 12C, and 13) disposed between the second lens circumferential portion (e.g., 422 in FIGS. 1 to 5, 6A, 6B, 7, 8A, 8B, 9A, 9B, 10, 11A to 11D, 12A to 12C, and 13) and the second support portion (e.g., 442 in FIGS. 1 to 5, 6A, 6B, 7, 8A, 8B, 9A, 9B, 10, 11A to 11D, 12A to 12C, and 13).

According to an embodiment of the disclosure, the lens assembly (e.g., 400 in FIGS. 1 to 5, 6A, 6B, 7, 8A, 8B, 9A, 9B, 10, 11A to 11D, 12A to 12C, and 13) may include a body tube (e.g., 410 in FIGS. 1 to 5, 6A, 6B, 7, 8A, 8B, 9A, 9B, 10, 11A to 11D, 12A to 12C, and 13) forming a space (e.g., 413 in FIGS. 1 to 5, 6A, 6B, 7, 8A, 8B, 9A, 9B, 10, 11A to 11D, 12A to 12C, and 13) therein, in which the lens is disposed, and including a first body tube circumferential portion (e.g., 411 in FIGS. 1 to 5, 6A, 6B, 7, 8A, 8B, 9A, 9B, 10, 11A to 11D, 12A to 12C, and 13) surrounding the first lens circumferential portion (e.g., 421 in FIGS. 1 to 5, 6A, 6B, 7, 8A, 8B, 9A, 9B, 10, 11A to 11D, 12A to 12C, and 13) and a second body tube circumferential portion (e.g., 412 in FIGS. 1 to 5, 6A, 6B, 7, 8A, 8B, 9A, 9B, 10, 11A to 11D, 12A to 12C, and 13) surrounding the second lens circumferential portion (e.g., 422 in FIGS. 1 to 5, 6A, 6B, 7, 8A, 8B, 9A, 9B, 10, 11A to 11D, 12A to 12C, and 13).

According to an embodiment of the disclosure, the second lens circumferential portion (e.g., 422 in FIGS. 1 to 5, 6A, 6B, 7, 8A, 8B, 9A, 9B, 10, 11A to 11D, 12A to 12C, and 13) may include a bending portion (e.g., 4221 and 4222 in FIGS. 1 to 5, 6A, 6B, 7, 8A, 8B, 9A, 9B, 10, 11A to 11D, 12A to 12C, and 13) connected to the first lens circumferential portion (e.g., 421 in FIGS. 1 to 5, 6A, 6B, 7, 8A, 8B, 9A, 9B, 10, 11A to 11D, 12A to 12C, and 13).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a display configured to output visual information; and
a lens assembly configured to allow the visual information output from the display to pass through,
wherein the lens assembly comprises:
a body tube forming a space therein,
a first lens including a first lens circumferential portion and a second lens circumferential portion, the first lens circumferential portion at least partially extending along a circumferential direction of the body tube, the second lens circumferential portion being connected to the first lens circumferential portion and forming a bending portion,
a second lens disposed inside the body tube and spaced apart from the first lens,
a support member disposed between the first lens and the second lens, the support member including a first support portion and a second support portion, the first support portion extending along the first lens circumferential portion, the second support portion corresponding to the second lens circumferential portion and being spaced apart from the second lens circumferential portion, and
a shielding member disposed between the second lens circumferential portion and the second support portion.

2. The wearable electronic device of claim 1, wherein a curvature of the first lens circumferential portion is greater than a curvature of the second lens circumferential portion.

3. The wearable electronic device of claim 1, wherein the lens assembly further comprises:
a first circumferential portion corresponding to the first lens circumferential portion; and
a second circumferential portion corresponding to the second lens circumferential portion.

4. The wearable electronic device of claim 1, wherein the body tube comprises:
a first body tube circumferential portion surrounding the first lens circumferential portion; and
a second body tube circumferential portion surrounding the second lens circumferential portion.

5. The wearable electronic device of claim 1, wherein the bending portion comprises:
a first bending portion connected to the first lens circumferential portion; and
a second bending portion connected to the first lens circumferential portion and spaced apart from the first bending portion.

6. The wearable electronic device of claim 1, wherein the second lens circumferential portion includes an extending portion formed convexly toward the support member.

7. The wearable electronic device of claim 1, wherein the second lens circumferential portion comprises:
a first recess formed in a direction away from the support member; and
a second recess formed in a direction away from the support member and spaced apart from the first recess.

8. The wearable electronic device of claim 1, wherein the second support portion comprises:
a first stepped portion connected to the first support portion; and
a second stepped portion connected to the first support portion and spaced apart from the first stepped portion.

9. The wearable electronic device of claim 1, wherein the second support portion includes a support frame spaced apart from the second lens circumferential portion and forming a gap between the support frame and the second lens circumferential portion.

10. The wearable electronic device of claim 1, wherein the shielding member comprises:
a first finishing portion disposed in a position in which the first lens circumferential portion and the second lens circumferential portion are connected;
a second finishing portion disposed in a position in which the first lens circumferential portion and the second lens circumferential portion are connected, the second finishing portion being spaced apart from the first finishing portion; and
a third finishing portion connecting the first finishing portion and the second finishing portion.

11. The wearable electronic device of claim 1,
wherein the second lens circumferential portion includes a lens surface inclined toward an outside of the lens assembly, and
wherein the shielding member contacts the lens surface.

12. The wearable electronic device of claim 1, wherein the shielding member comprises:
a first finishing surface in contact with the second support portion;
a second finishing surface in contact with the second lens circumferential portion; and
a third finishing surface connecting the first finishing surface and the second finishing surface and inclined toward an inside of the lens assembly.

13. The wearable electronic device of claim 1, wherein the shielding member comprises:
a first portion disposed between the second lens circumferential portion and the second support portion;
a second portion protruding from the first portion toward an inside of the lens assembly; and
a buffer member disposed in the second portion.

14. The wearable electronic device of claim 1, wherein the lens assembly further comprises:
an adhesive member disposed between the shielding member and the second support portion.

15. The wearable electronic device of claim 1, wherein the shielding member is formed integrally with the support member.

16. A wearable electronic device, comprising:
a display configured to output visual information; and
a lens assembly configured to allow the visual information output from the display to pass through, the lens assembly including a first circumferential portion and a second circumferential portion having a curvature smaller than a curvature of the first circumferential portion,
wherein the lens assembly comprises:
a lens including a first lens circumferential portion corresponding to the first circumferential portion and a second lens circumferential portion corresponding to the second circumferential portion;
a support member including a first support portion coupled to the first lens circumferential portion and a second support portion connected to the first support portion and spaced apart from the second lens circumferential portion; and
a shielding member disposed between the second lens circumferential portion and the second support portion.

17. The wearable electronic device of claim 16, wherein a curvature of the first lens circumferential portion is greater than a curvature of the second lens circumferential portion.

18. The wearable electronic device of claim 16, wherein the lens assembly further comprises a body tube forming a space in which the lens is disposed, the body tube including a first body tube circumferential portion surrounding the first lens circumferential portion and a second body tube circumferential portion surrounding the second lens circumferential portion.

19. The wearable electronic device of claim 16, wherein the second lens circumferential portion comprises a bending portion connected to the first lens circumferential portion.

20. The wearable electronic device of claim 16, wherein the shielding member is formed integrally with the support member.
